(19) United States
(12) Patent Application Publication
(10) Pub. No.: US 2005/0282936 A1
(43) Pub. Date: Dec. 22, 2005

(54) Cationic electrodeposition coating composition

(76) Inventors: Teruzo Toi, Osaka-fu (JP); Naotaka Kitamura, Osaka-fu (JP); Mitsuo Yamada, Osaka-fu (JP)

Correspondence Address: WENDEROTH, LIND & PONACK, L.L.P., 2033 K STREET N. W., SUITE 800, WASHINGTON, DC, 20006-1021, US

(21) Appl. No.: 11/153,547

(22) Filed: Jun. 16, 2005

(30) Foreign Application Priority Data
Jun. 16, 2004 (JP) 2004-178277

(51) Int. Cl. C08L 63/00; B05D 3/02; B32B 27/38

(52) U.S. Cl. 523/414; 523/402; 427/386; 428/413

(57) ABSTRACT

The present invention provides a cationic electrodeposition coating composition which can provide an electrodeposition coating film having low specular gloss and excellent finished appearance. The present invention relates to a cationic electrodeposition coating composition comprising a cationic emulsion (A) which comprises (a) a cationic epoxy resin and (c) a blocked isocyanate curing agent, and a cationic emulsion (B) which comprises (b) at least one resin selected from the group consisting of a cation-modified acrylic resin and a cationic epoxy resin other than the cationic epoxy resin (a) and (d) a blocked isocyanate curing agent, wherein
a difference Δδ_{A-B} between a solubility parameter δ_{A} of a resin component in the cationic emulsion (A) and a solubility parameter δ_{B} of a resin component in the cationic emulsion (B) is within a range of from 0.5 to 1.5, and
a difference ΔT_{A-B} between a curing-initiation temperature (T_{A}) of the cationic emulsion (A) and a curing-initiation temperature (T_{B}) of the cationic emulsion (B) is within a range of from 20° C. to 60° C.

### FIELD OF THE INVENTION

The present invention relates to an electrodeposition coating composition which can provide a electrodeposition coating film having low specular gloss and excellent finished appearance.

### BACKGROUND OF THE INVENTION

An article with less-luster gloss coating film or mat coating film having low specular gloss typically gives optical sedate impression and looks good. These less-luster or mat finishes have been desired and required more in recent years. In the meantime, an electrocoating method is a coating method which can perform application automatically and has a high coating efficiency. Because of the advantages of the electrocoating method, the use of the electrocoating process for preparing the less-luster gloss coating film or mat coating film has been desired.

An electrodeposition coating composition which is known to provide less-luster gloss coating film or mat coating film may be one that is obtained by adding an additives such as white carbon, silica particle or aluminum silicate to an electrodeposition coating composition or that increases a pigment volume concentration (PVC). These electrodeposition coating compositions provide an electrodeposition coating film having a surface with microscopic roughness, which causes effect of less-luster gloss or mat effect.

Japanese Patent Kokai Publication No. 2000-309742 discloses an additive for a mat coating composition which comprises a polyvinyl chloride particle having an average particle size of 0.5 to 70 μm. The publication discloses that a mat coating film having a surface with microscopic roughness can be obtained by adding the particle to a coating composition.

The mat effect obtained by adding a resin particle such as polyvinyl chloride particle to a cation electrodeposition coating composition is mainly obtained by an exposure of the resin particles in a coating film, which results from a difference of compatibility between a cation electrodeposition coating composition and the resin particle such as cationic gel particle and polyvinyl chloride particle, when curing the surface with the microscopic roughness reflects light to scatter, which causes mat effect. However, adding an additive such as the resin particle may cause increase of viscosity of the coating composition when curing, which may deteriorate appearance of a cured coating film. In addition, the additive may be precipitated and agglutinate in the coating composition. The agglutinated particles may produce roughness on the surface of the coating composition, which is distinguishable by eyes and which deteriorates appearance of a cured coating film.

An example of forming a mat coating film from an anionic electrodeposition coating composition includes a method for using a component having alkoxysilyl group as described in Japanese Patent Kokai Publication No. Hei 5(1993)-171100. The method seems to achieve formation of the mat coating film by generating a microgel in the coating composition to provide a coating film having a surface with microscopic roughness, which reflects light diffusely to scatter and causes mat effect. A cationic electrodeposition coating composition generally provides a coating film having higher corrosion resistance than an anionic coating composition. It is advantageous to provide a method for forming a mat coating film by electrocoating a cationic electrodeposition coating composition.

Japanese Patent Kokai Publication No. 2000-144022 discloses a mat anionc electrodeposition coating composition which contains the following components as curable resin components: (A) 29.9 to 84% by weight of a water-dispersible resin having alkoxysilyl groups on the side chain, with an acid value of 15-80 KOHmg/g, a hydroxyl number of 30-200 KOHmg/g and a solubility parameter of 9.0 to 11.6; (B) 0.1 to 20% by weight of a resin having an acid value of 0-200 KOHmg/g, a hydroxyl number of 30-200 KOHmg/g and a solubility parameter of 9.1 to 13.1, with the solubility parameter being greater than that of the resin A by 0.1 to 1.5; and (C) 15 to 50% by weight of a crosslinking agent. The water-dispersible resin (A) having alkoxysilyl groups seems to be a resin component for providing a mat coating film judging from the description in 0008 paragraph in the specification. It is however difficult to use such water-dispersible resin having alkoxysilyl groups in a cationic electrodeposition coating composition because the cationic electrodeposition coating composition has antipolarity-relative to an anionic electrodeposition coating composition.

### OBJECTS OF THE INVENTION

The present invention is to find solutions to problems described above. A main object of the present invention is to provide a cationic electrodeposition coating composition which can provide a electrodeposition coating film having low specular gloss and excellent finished appearance.

### SUMMARY OF THE INVENTION

The present invention provides a cationic electrodeposition coating composition comprising a cationic emulsion (A) which comprises (a) a cationic epoxy resin and (c) a blocked isocyanate curing agent, and a cationic emulsion (B) which comprises (b) at least one resin selected from the group consisting of a cation-modified acrylic resin and a cationic epoxy resin other than the cationic epoxy resin (a) and (d) a blocked isocyanate curing agent, wherein
a difference Δδ_{A-B} between a solubility parameter δ_{A} of a resin component in the cationic emulsion (A) and a solubility parameter δ_{B} of a resin component in the cationic emulsion (B) is within a range of from 0.5 to 1.5, and
a difference ΔT_{A-B} between a curing-initiation temperature (T_{A}) of the cationic emulsion (A) and a curing-initiation temperature (T_{B}) of the cationic emulsion (B) is within a range of from 20° C. to 60° C.

It is preferred that a solid content ratio A/B by weight of the cationic emulsion (A) and the cationic emulsion (B) is within a range of from 95/5 to 60/40.

The present invention also provides a process for forming a cured electrodeposition coating film having a specular gloss within a range of from 50% to 70%, comprising the steps of;
electrocoating the cationic electrodeposition coating composition, and
heating the resulting electrodeposition coating film to cure.

The cationic electrodeposition coating composition of the present invention can provide a cured electrodeposition coating film having low specular gloss without adding a particulate matting agent thereto. The cationic electrodeposition coating composition of the present invention can provide an electrodeposition coating film having low specular gloss and excellent finished appearance by electrocoating the cationic electrodeposition coating composition.

### BRIEF DESCRIPTION OF THE DRAWINGS

FIG. 1 is a schematic diagram showing a relation between sample temperature and sample viscocity in order to explain a method of calculating curing-initiation temperature (T).

### DETAILED DESCRIPTION OF THE PREFERRED EMBODIMENTS

The cationic electrodeposition coating composition of the present invention contains at least two emulsions of cationic emulsion (A) and a cationic emulsion (B). The cationic emulsion (A) contains a cationic epoxy resin (a) and a blocked isocyanate curing agent (c). The cationic emulsion (B) contains (b) at least one resin selected from the group consisting of a cation-modified acrylic resin and a cationic epoxy resin other than the cationic epoxy resin (a) and (d) a blocked isocyanate curing agent. A difference Δδ_{A-B} between a solubility parameter δ_{A} of a resin component in the cationic emulsion (A) and a solubility parameter δ_{B} of a resin component in the cationic emulsion (B) is within a range of from 0.5 to 1.5. And a difference ΔT_{A-B} between a curing-initiation temperature (T_{A}) of the cationic emulsion (A) and a curing-initiation temperature (T_{B}) of the cationic emulsion (B) is within a range of from 20° C. to 60° C. The details are discussed later.

Cationic Emulsion (A)

The cationic emulsion (A) contains a cationic epoxy resin (a) and a blocked isocyanate curing agent (c). The cationic epoxy resin (a) includes an amine-modified epoxy resin.

The cationic epoxy resin are typically made by opening all epoxy rings of a bisphenol epoxy resin with an amine compound; or by opening a part of the epoxy rings with the other activated hydrogen compound and opening the residual epoxy rings with an amine compound.

Examples of the bisphenol epoxy resins include bisphenol A type epoxy resins and bisphenol F type epoxy resins. Examples of the bisphenol A type epoxy resins, which are commercially available from Yuka Shell Epoxy Co., Ltd., include Epikote 828 (epoxy equivalent value: 180 to 190), Epikote 1001 (epoxy equivalent value: 450 to 500), Epikote 1010 (epoxy equivalent value: 3000 to 4000) and the like. Examples of the bisphenol F type epoxy resins, which are commercially available from Yuka Shell Epoxy Co., Ltd., include Epikote 807 (epoxy equivalent value: 170) and the like.

Oxazolidone ring containing epoxy resin having the following formula; 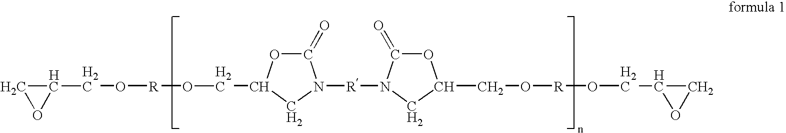
wherein, R represents a residual group obtained by removing glycydyl group from diglycidyl epoxy compound, R′ represents a residual group obtained by removing isocyanate group from diisocyanate compound, and n represents a positive integer;
   may be used as the cationic epoxy resin. The oxazolidone ring containing epoxy resin can provide the cationic electrodeposition coating composition which can make a coating film having excellent heat resistance and corrosion resistance. The epoxy resin is disclosed in Japanese Patent Kokai Publication No. Hei 5(1993)-306327. Japanese Patent Kokai Publication No. Hei 5(1993)-306327 is a priority patent application of U.S. Pat. No. 5,276,072, which is herein incorporated by reference.

A method of introducing the oxazolidone ring into the epoxy resin includes a method comprising the steps of heating the blocked isocyanate curing agent blocked with lower alcohol such as methanol and polyepoxide under basic catalyst and keeping its heating temperature constant, and distilling off the by-product lower alcohol from the system.

The particularly preferred epoxy resin is the oxazolidone ring containing resin. Using the oxazolidone ring containing resin can provide the coating film which is superior in heat resistance, corrosion resistance and impact resistance.

It is well known that the epoxy resin containing oxazolidone ring can be obtained by reaction of bifunctional epoxy resin with diisocyanate blocked with monoalcohol (that is, bisurethane). The specific examples of the oxazolidone ring containing epoxy resin and the preparing method thereof are disclosed in paragraphs [0012] to [0047] of Japanese Patent Kokai Publication No. 2000 128959, which are well known. Japanese Patent Kokai Publication No. 2000-128959 is a priority patent application of U.S. Pat. No. 6,664,345, which is herein incorporated by reference.

The epoxy resin may be modified with suitable resins, such as polyesterpolyol, polyetherpolyol, and monofuctional alkylphenol. In addition, the epoxy resin can be chain-extended by the reaction of epoxy group with diol or dicarboxylic acid.

It is desired for the epoxy resin to be ring-opened with activated hydrogen compound such that they have an amine equivalent value of 0.3 to 4.0 meq/g after ring opening, and particularly 5 to 50% thereof is primary amino group.

A typical example of the activated hydrogen compounds, into which a cationic group can be introduced, includes primary amine, secondary amine. A reaction of the epoxy resin with a secondary amine provides an amine-modified epoxy resin (cationic epoxy resin) having tertiary amino group. A reaction of the epoxy resin with a primary amine provides an amine-modified epoxy resin having secondary amino group. A reaction of the epoxy resin with a resin having primary amino group and secondary amino group provides an amine-modified epoxy resin having primary amino group. In case of using a resin having primary amino group and secondary amino group, the amine-modified epoxy resin can be prepared by the method including the following steps;
blocking primary amino group of the resin having primary amino group and secondary amino group with a ketone to produce a ketimine before reacting with the epoxy resin,
introducing the ketimine into the epoxy resin, and
deblocking the ketone to produce the cationic epoxy resin having primary amino group.

The specific example of the primary amine, the secondary amine and the ketimine includes butylamine, octylamine, diethylamine, dibutylamine, methylbutylamine, monoethanolamine, diethanolamine, N-methylethanolamine, triethylamine hydrochloride, N,N-dimethylethanolamine acetate, mixture of diethyldisulfide and acetic acid thereof, as well as secondary amines obtained by blocking primary amines, such as ketimine of aminoethylethanolamine, diketimine of diethylenetriamine and the like. The amines may be used in combination.

A number average molecular weight of the cationic epoxy resin (a) may preferably be within the range of from 1500 to 5000. When the number average molecular weight is smaller than 1500, properties of a cured coating film such as solvent resistance or corrosion resistance may be poor. On the other hand, when the number average molecular weight is larger than 5000, controlling viscosity of a resin solution and preparation of the coating composition may be difficult. In addition, handling the cationic emulsion (A) such as emulsifying may be difficult. Furthermore, poor appearance of the coating film may be obtained because of poor flow property owing to high viscosity.

The Blocked isocyanate curing agent (c) is a curing agent that an isocyanate group of a polyisocyanate in the blocked isocyanate curing agent (c) is blocked. Polyisocyanate used for preparing the blocked isocyanate curing agent (c) of the present invention is a compound having at least two isocyanate groups in one molecular. The polyisocyanates may be anyone of aliphatic type, cycloaliphatic type, aromatic type or aromatic-aliphatic type.

Examples of the polyisocyanates include aromatic diisocyanates, such as tolylene diisocyanate (TDI), diphenylmethane diisocyanate (MDI), p-phenylene diisocyanate and naphthalene diisocyanate; aliphatic diisocyanates having 3 to 12 carbon atoms, such as hexamethylene diisocyanate (HDI), 2,2,4-trimethylhexane diisocyanate and lysine diisocyanate; cycloaliphatic diisocyanates having 5 to 18 carbon atoms, such as 1,4-cyclohexane diisocyanate (CDI), isophorone diisocyanate (IPDI), 4,4′-dicyclohexylmethane diisocyanate (hydrogenated MDI), methylcyclohexane diisocyanate, isopropylidenedicyclohexyl-4,4′-diisocyanate and 1,3-diisocyanatomethylcyclohexane (hydrogenated XDI), hydrogenated TDI, 2,5- or 2,6-bis(isocyanate methyl)-bicyclo[2.2.1]heptane (referred to as norbornane diisocyanate); aliphatic diisocyanates having aromatic ring, such as xylylene diisocyanate (XDI) and tetramethylxylylene diisocyanate (TMXDI); modified compounds thereof (such as urethane compound, carbodiimide, urethodion, urethonimine, biuret and/or isocyanurate modified compound); and the like. The polyisocyanate may be used alone or in combination of two or more.

Adducts or prepolymers obtained by reacting the polyisocyanate with polyalcohols such as ethylene glycol, propylene glycol, trimethylolpropane and hexanetriol at a NCO/OH ratio of not less than 2 may also be used as the blocked isocyanate curing agent.

The block agent is a compound which can adduct to polyisocyanate group to be stable at room temperature, but reproduce free isocyanate group by heating to a temperature more than a dissociation temperature.

The blocking agent can be α-caprolactam and ethylene glycol monobutyl ether (butyl cellosolve) that are usually used.

Preparation of Cationic Emulsion (A)

The cationic emulsion (A) can be prepared by dispersing the cationic epoxy resin (a) and the blocked isocyanate curing agent (c) in an aqueous solvent. A neutralizing acid may be contained in the aqueous solvent, in order to enhance dispersibility by neutralizing the cationic epoxy resin (a). Examples of the neutralizing acid include inorganic acids or organic acids, such as hydrochloric acid, nitric acid, phosphoric acid, formic acid, acetic acid, lactic acid, sulfamic acid, acetylglycine or the like. The aqueous solvent as used herein is water or a mixture of water and an organic solvent. Water may preferably be ion exchanged water. A typical example of the organic solvent includes hydrocarbons such as xylenes and toluenes;
alcohols such as methyl alcohol, n-butyl alcohol, isopropyl alcohol, 2-ethylhexyl alcohol, ethylene glycol and propylene glycol;
ethers such as ethylene glycol monoethyl ether, ethylene glycol monobuthyl ether, ethylene glycol monohexyl ether, propylene glycol monoethyl ether, 3-methyl-3-methoxy butanol, diethylene glycol monoethyl ether and diethylene glycol monobutyl ether;
ketones such as methyl isobutyl ketone, cyclohexanone, isophorone and acetylacetone;
esters such as ethylene glycol monoethyl ether acetate and ethylene glycol monobutyl ether acetate;
or mixtures thereof.
   Using an organic solvent in the cationic emulsion can improve flow property of the coating film under heating to obtain a coating film having excellent finished appearance.

It is desired for an amount of the blocked isocyanate curing agent to be sufficient to react with activated hydrogen containing functional group, such as primary amino group, secondary amino group, and hydroxyl group during curing to provide good cured coating film. The amount of the blocked isocyanate curing agent, which is represented by a solid content ratio of the cationic epoxy resin to the blocked isocyanate curing agent (the cationic epoxy resin/curing agent), is typically within the range of preferably 90/10 to 50/50, more preferably 80/20 to 65/35. An amount of the neutralizing acid may preferably be the amount enough to neutralize at least 20% by weight of cationic groups in the cationic epoxy resin, more preferably the amount enough to neutralize 30 to 60% by weight of cationic groups in the cationic epoxy resin.

The resin component in cationic emulsion (A) may preferably be molecular-designed such that its hydroxyl value is within the range of from 50 to 250. When the hydroxyl number is smaller than 50, defective curing of the coating film may be obtained. On the other hand, when the hydroxyl number is larger than 250, the coating film having poor water resistance may be obtained because of an existence of too many hydroxyl group in a cured coating film.

Cationic Emulsion (B)

The cationic emulsion (B) contains (b) at least one resin selected from the group consisting of a cation-modified acrylic resin and a cationic epoxy resin other than the cationic epoxy resin (a) (hereinafter, referred to as “resin (b)”); and a blocked isocyanate curing agent (d).

The blocked isocyanate curing agent (d) in the cationic emulsion (B) may be one that is described as the blocked isocyanate curing agent (c) in the cationic emulsion (A).

The cationic epoxy resin in the cationic emulsion (B) may include the cationic epoxy resin same as described in the cationic epoxy resin (a) in the cationic emulsion (A), provided that the cationic epoxy resin in the cationic emulsion (B) is different from the cationic epoxy resin (a) in the cationic emulsion (A). The term “cationic epoxy resin other than the cationic epoxy resin (a)” in the resin (b) as used herein refers to a cationic epoxy resin having a different solubility parameter relative to a solubility parameter of the cationic epoxy resin (a), and having a different curing-initiation temperature relative to a curing-initiation temperature of the cationic epoxy resin (a). Even when the cationic emulsion (B) contains only the cationic epoxy resin and does not contain a cation-modified acrylic resin, the cationic electrodeposition coating composition should meet the following relation; a difference Δδ_{A-B} between a solubility parameter δ_{A} of a resin component in the cationic emulsion (A) and a solubility parameter δ_{B} of a resin component in the cationic emulsion (B) is within a range of from 0.5 to 1.5, and; a difference ΔT_{A-B} between a curing-initiation temperature (T_{A}) of the cationic emulsion (A) and a curing-initiation temperature (T_{B}) of the cationic emulsion (B) is within a range of from 20° C. to 60° C.

An example of obtaining the cation-modified acrylic resin is a ring opening addition polymerization of acrylic copolymer containing both plural oxirane rings and hydroxyl groups in a molecular with amines. The acrylic copolymer may be obtained by copolymerizing (i) glycidyl (meth)acrylate; (ii) hydroxyl group containing acrylic monomer (for example, addition product of ε-caprolactone and hydroxyl group containing (meth)acrylic ester, such as 2-hydroxymethyl (meth)acrylate, 2-hydroxypropyl (meth)acrylate, 2-hydroxybutyl (meth)acrylate, or 2-hydroxyethyl (meth)acrylate); and (iii) the other acrylic monomer and/or non-acrylic monomer.

Examples of the other acrylic monomers (iii) include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, cyclohexyl (meth)acrylate, 2-ethylhexyl (meth)acrylate, lauryl (meth)acrylate, isobornyl (meth)acrylate and the like. Examples of the non-acrylic monomers include styrene, vinyl toluene, α-methylstyrene, (meth)acrylonitrile, (meth)acrylamide, vinyl acetate and the like.

An oxirane ring-containing acrylic resin formed from the glycidyl (meth)acrylate can be converted into a cation-modified acrylic resin by opening all oxirane rings in the epoxy resin by the reaction with primary amine, secondary amine or an acid salt of tertiary amine.

The cation-modified acrylic resin may be directly synthesized by a method of copolymerizing acrylic monomer having amino group and the other monomer. In the method, the glycidyl (meth)acrylate is replaced with amino group containing acrylic monomer, such as N,N-dimethylaminoethyl (meth)acrylate, N,N-dimethylaminopropyl (meth)acrylamide and N,N-di-t-butylaminoethyl (meth)acrylate, and the cation-modified acrylic resin can be obtained by copolymerizating the amino group containing acrylic monomer, the hydroxyl group containing acrylic monomer and the other acrylic monomer and/or non-acrylic monomer.

The resulting cation-modified acrylic resin may be self-crosslinkable acrylic resin which may be obtained by incorporating a blocked isocyanate group to the acrylic polymer backbone by an addition reaction with a half-blocked diisocyanate compound, as described in Japanese Patent Kokai Publication No. Hei 8(1996)-333528.

It is desired for the resin (b) to have a number average molecular weight of 1,000 to 20,000. When the number average molecular weight is lower than 1,000, the physical properties of the resulting cured coating film, such as solvent resistance, may be poor. On the other hand, when the number average molecular weight is higher than 20,000, the viscosity of the resin solution is high, and it is difficult to handle in operation, such as emulsification and dispersion of the resulting resin. In addition, the appearance of the resulting coating film may be poor.

The resin (b) may preferably be the cation-modified acrylic resin. When the cation-modified acrylic resin is used as the resin (b), the cationic electrodeposition coating composition contains both the cationic epoxy resin and the cation-modified acrylic resin. The cationic electrodeposition coating composition containing both the cationic epoxy resin and the cation-modified acrylic resin can provide less-luster gloss effect of the coating film resulting from irregular reflection of light owing to difference of refractive index between two different resins, as well as less-luster gloss effect of the coating film resulting from a curing strain of the coating.

Preparation of Cationic Emulsion (B)

The cationic emulsion (B) can be prepared by dispersing the resin (b) and the blocked isocyanate curing agent (d) in an aqueous solvent. The cationic emulsion (B) can be prepared in the same way as the preparation of the cationic emulsion (A). It is desired for an amount of the blocked isocyanate curing agent (d) to be sufficient to react with activated hydrogen-containing functional group in the resin (b) during curing to provide good cured coating film. An amount of the blocked isocyanate curing agent, which is represented by a solid content ratio of the resin (b) to the blocked isocyanate curing agent (d) (the resin (b)/curing agent (d)), is typically within the range of preferably 90/10 to 50/50, more preferably 80/20 to 65/35. An amount of the neutralizing acid may preferably be enough to neutralize at least 20% by weight of cationic groups in the resin (b), more preferably the amount enough to neutralize 30 to 60% by weight of cationic groups in the resin (b).

A hydroxyl number of the resin component in cationic emulsion (B) may preferably be in the range of from 50 to 150. When the hydroxyl number is smaller than 50, defective curing of the coating film may be obtained. On the other hand, when the hydroxyl number is larger than 150, the coating film having poor water resistance may be poor because excess of many hydroxyl group remains in the cured coating film.

Pigment

The cationic electrodeposition coating composition used in the process of the present invention may contain pigment, which has been conventionally used for a coating. Examples of the pigments include inorganic pigments, for example, a coloring pigment, such as titanium dioxide, carbon black and colcothar; an extender pigment, such as kaolin, talc, aluminum silicate, calcium carbonate, mica and clay; a rust preventive pigment, such as zinc phosphorate, iron phosphorate, aluminum phosphorate, calcium phosphorate, zinc phosphite, zinc cyanide, zinc oxide, aluminum tripolyphosphorate, zinc molybdate, aluminum molybdate, calcium molybdate, aluminum phosphomolybdate, aluminum zinc phosphomolybdate and the like.

When the pigment is used as a component of the electrodeposition coating composition, the pigment is generally pre-dispersed in an aqueous solvent at high concentration in the form of a paste (pigment dispersed paste). It is difficult to uniformly disperse the pigment at low concentration in one step because of powdery form of the pigment. The paste is generally called pigment dispersed paste.

The pigment dispersed paste is prepared by dispersing the pigment together with pigment dispersing resin varnish in an aqueous medium. As the pigment dispersing resin, cationic or non-ionic low molecular weight surfactant, or cationic polymer such as modified epoxy resin having quaternary ammonium group and/or tertiary sulfonium group can be used. As the aqueous medium, deionized water or water containing a small amount of alcohol can be used. The pigment dispersing resin is generally used at the solid content of 20 to 100 parts by weight based on 100 parts by weight of the coating composition. The pigment dispersed paste can be obtained by mixing the pigment dispersing resin varnish with the pigment, and dispersing the pigment using a suitable dispersing apparatus, such as a ball mill or sand grind mill.

When the pigment is used as a component of the electrodeposition coating composition, a content of the pigment may preferably be not more than 30% by weight based on the solid components of the coating composition. If the content of the pigment is more than 30% by weight, it may induce a poor horizontal appearance of the resulting cationic electrodeposition coating film because of sedimentation of the pigment.

The cationic electrodeposition coating composition according to the present invention provides a cured electrodeposition coating film having low specular gloss without adding a particulate matting agent thereto such as the particle described in Japanese Patent Kokai Publication No. 2000-309742. However, the present invention is not intended to exclude formulation of such particulate additive. In the present invention, a particulate additive may be added to the cationic electrodeposition coating composition to control specular gloss of the resulting cured coating film.

Cationic Electrodeposition Coating Composition

The cationic electrodeposition coating composition of the present invention can be obtained by mixing the cationic emulsion (A) and the cationic emulsion (B), and optionally the pigment dispersed paste and a catalyst.

In the cationic electrodeposition coating composition of the present invention, a difference Δδ_{A-B} between a solubility parameter δ_{A} of a resin component in the cationic emulsion (A) and a solubility parameter δ_{B} of a resin component in the cationic emulsion (B) is within a range of from 0.5 to 1.5. The difference Δδ_{A-B} may be more preferably within a range of from 0.5 to 1.0. The symbol “Δδ_{A-B}” as used herein represents a figure obtained from the calculating formula: δ_{A}-δ_{B}. When the cationic emulsion (A) or the cationic emulsion (B) is composed of two or more kinds of resin components, the two or more kinds of resin components are preliminarily mixed, and a solubility parameter δ_{A} or δ_{B} of the mixture is determined. In general, two kinds of resin components are slightly incompatible with each other in case where a difference in solubility parameter between the two kinds of resin components Δδ is more than 0.2. When difference in solubility parameter Δδ is more than 0.5, the two kinds of resin components separate each other to make a separation structure. When difference in solubility parameter Δδ is more than 1.5, the two kinds of resin components excessively separate each other, which may deteriorate appearance of the coating film.

In the present invention, the resin component in the cationic emulsion (A) is composed of a resin component of the cationic epoxy resin (a) and the blocked isocyanate curing agent (c). The resin component in the cationic emulsion (B) is composed of (b) at least one resin selected from the group consisting of a cation-modified acrylic resin and a cationic epoxy resin other than the cationic epoxy resin (a) and (d) the blocked isocyanate curing agent.

Solubility parameter shows a measuring criterion which indicats degree of hydrophilicity or hydrophobicity. The cationic emulsion (A) having greater δ_{A} than δ_{B} of the cationic emulsion (B) generally have high affinity with the surface of electrically conductive substrate having high surface polarity (such as metal) rather than air-side surface. Consequently, the resin component of the cationic emulsion (A) tends to form a resin layer on the surface of electrically conductive substrate such as metal materials. On the other hand, the cationic emulsion (B) moves to air-side to form a resin layer. The difference in solubility parameter of the resins in both cationic emulsions (A) and (B) probably promotes to stratify the resin layer.

For adjusting Δδ_{A-B} within the above range, the solubility parameters of the resin components in the cationic emulsions (A) and (B) are measured and selected to satisfy the relation.

The term “solubility parameter δ” as used herein is generally called by persons skilled in the art as SP, which shows a measuring criterion which indicates degree of hydrophilicity or hydrophobicity, and is an important criterion to consider compatibility between resins. When the solubility parameter of a component is higher, the component has high polarity. On the other hand, when the solubility parameter of a component is lower, the component has low polarity.

A value of solubility parameter can be determined by a method called as turbidimetric method, which is well known to the art. A value of solubility parameter can be measured by the following method (see, K. W. Suh, D. H. Clarke J. Polymer Sci., A-1, 5, 1671 (1967)). When the cationic emulsion (A) or the cationic emulsion (B) is composed of two or more kinds of resin components, the two or more kinds of resin components are preliminarily mixed, and a solubility parameter δ_{A} or δ_{B} of the mixture is determined.

Measured Temperature: 20° C.

Sample: a resin (0.5 g) is weighted in a 100 ml beaker and 10 ml of a good solvent is added with a pipette to the beaker, then the mixture is dissolved with a magnetic stirrer.

Solvent:
good solvent: dioxane, acetone or the like
poor solvent: n-hexane, ion exchanged water or the like

Measurement of turbidity point: a poor solvent is added dropwise into the sample with a 50 ml burette until generation of turbidity in the sample is observed. An amount of added poor solvent is determined.

Solubility parameter δ of a resin is obtained from the following mathematical formulae:
δ=(Vₘₗ^{1/2}δₘₗ+Vₘₕ^{1/2}δₘₕ)/(Vₘₗ^{1/2}+Vₘₕ^{1/2})
Vₘ=V₁V₂/(φ₁V₂+φ₂V₁)
δₘ=φ₁+φ₂δ₂
Vᵢ: molecular volume of a solvent (ml/mol)
Φᵢ: volume fraction of each solvent in turbidity point
δᵢ: SP of solvent
ml: mixture of low SP poor solvent
mh: mixture of high SP poor solvent

In the cationic electrodeposition coating composition of the present invention, a difference ΔT_{A-B} between a curing-initiation temperature (T_{A}) of the cationic emulsion (A) and a curing-initiation temperature (T_{B}) of the cationic emulsion (B) is within a range of from 20° C. to 60° C. The difference ATA-B may be more preferably within a range of from 20° C. to 50° C. The symbol “ΔT_{A-B}” as used herein represents a figure obtained from the calculating formula: T_{A}-T_{B}. For adjusting the curing-initiation temperature T_{A} and T_{B}, an isocyanate backbone constituting blocked isocyanate curing agent and a block agent can be suitably selected. For example, a curing-initiation temperature can be lowered by selecting an isocyanate backbone having higher reactivity and a block agent having higher dissociation.

It is believed that the reason why the coating film of the present invention has low specular gloss is as follows, although it is not limited to specific theory. In the electrodeposition coating film according to the present invention, the cationic emulsions (A) having higher solubility parameter δ_{A} can move to the surface of electrically conductive substrate to form a resin layer. The cationic emulsions (B) can move to air-side to form a resin layer. In the present invention, the curing-initiation temperature (T_{A}) of the cationic emulsion (A) is higher than the curing-initiation temperature (T_{B}) of the cationic emulsion (B) by at least 20° C. When the resulting electrodeposition coating film having substantial separate layers is cured by heating, the cationic emulsions (B) which constitutes an air-side resin layer in the coating film firstly starts to cure. At the time when the cationic emulsions (A) which constitutes a resin layer on the surface of electrically conductive substrate in the coating film is followed to cure, the air-side resin layer in the coating film has already been cured as a whole. Curing resin layer on the surface of electrically conductive substrate (the cationic emulsions (A)) in the circumstance can provide curing strain on the air-side resin layer which has been cured. It is believed that the curing strain can lower the specular gloss of the cured coating film.

The curing strain can be controlled by adjusting the curing-initiation temperatures (T_{A}) and (T_{B}) of the cationic emulsions (A) and (B). Using the cationic emulsions (A) and (B) whose the curing-initiation temperatures (TA) and (TB) satisfy the above relation enables the formation of the cured electrodeposition coating film having excellent finished appearance and low specular gloss.

The term “electrodeposition coating film” as used herein refers to an uncured coating film obtained by electrocoating before it is cured by heating. The terms “cured electrodeposition coating film” and “cured coating film” as used herein refer to a cured coating film obtained by curing the electrodeposition coating film.

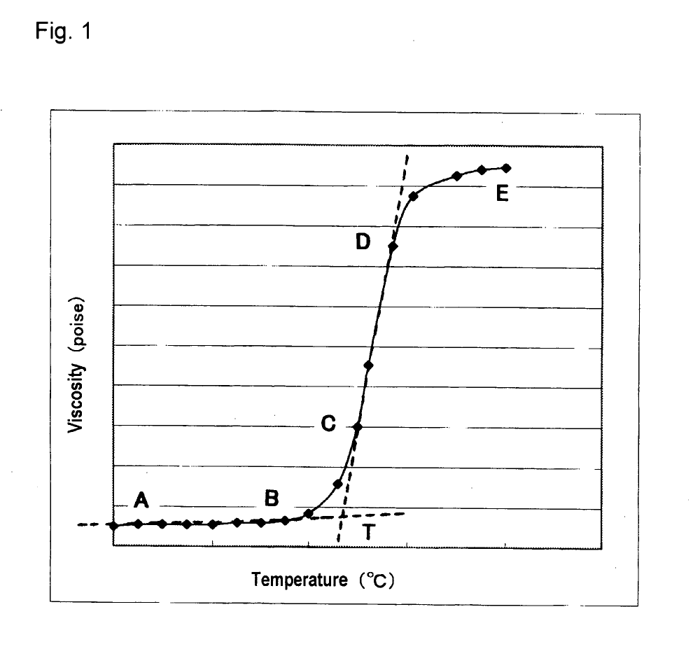

A curing-initiation temperature (T) of an emulsion can be determined by measuring dynamic viscoelasticity of the emulsion. A method for measuring a curing-initiation temperature is explained using FIG. 1. First, dynamic viscoelasticity of a thermosetting composition is measured under constant frequency. FIG. 1 is a graph illustrating a relation of temperature and viscosity of a sample of a thermosetting composition. In FIG. 1, A-B section in the graph shows an uncure state of the sample before heat-curing. B-C section in the graph shows a start-curing state of the sample. C-D section shows a state on curing the sample. E section shows a state after curing the sample. A curing-initiation temperature (T) can be obtained from a measurement result of dynamic viscoelasticity: making a regression line 1 of A-B section in the uncure state (showing a dotted line in FIG. 1) and a regression line 2 of C-D section in the state on curing (showing a dotted line in FIG. 1), and obtaining a temperature T at the intersection of the line 1 with the line 2. A curing-initiation temperature (T) can be determined by using a viscoelasticity measuring instrument such as RHEOSOL-G3000 produced by UBM CORPORATION.

An amount of the cationic emulsion (A) and the cationic emulsion (B), which is represented by a solid content ratio of the cationic emulsion (A) to the cationic emulsion (B) (the cationic emulsion (A)/the cationic emulsion (B)), is typically within the range of preferably 95/5 to 60/40, more preferably 90/10 to 70/30. When the amount of the cationic emulsion (B) is lower than the above range, the desired less-luster gloss coating film may not be obtained. When the amount of the cationic emulsion (B) is higher than the above range, finish appearance of the coating film may be deteriorated because of too first curing of the coating film.

The cationic electrodeposition coating composition may optionally contain a catalyst. An example of the catalyst includes a dissociation catalyst for dissociating a block agent from a blocked isocyanate curing agent. Specific example of the catalyst includes for example organic tin compounds such as dibutyltin dilaurate, dibutyltin oxide, dioctyltin oxide; amines such as N-methyl morpholine; lead acetate; metal salts of strontium, cobalt, cupper or the like. An amount of the catalyst may preferably be from 0.1 to 6 parts by weight based on 100 parts of the solid content of the binder resin in the cationic electrodeposition coating composition.

The cationic electrodeposition coating composition may contain additives for a coating, such as a plasticizer, surfactant, antioxidant and ultraviolet absorber, in addition to the above components.

The cationic electrodeposition coating composition of the present invention is electrocoated onto a substrate to form the electrodeposition coating film. The substrate can be anyone as long as it has electric conductivity, for example iron plate, steel plate, aluminum plate, surface-treated one thereof, or a molded article thereof.

Electrocoating is carried out by applying a voltage of usually 100 to 400 V between a substrate serving as cathode and an anode. An electrodeposition bath temperature may generally be controlled at 15 to 45° C. during electrocoating. A film thickness of the resulting coating film may be preferably within a range of from 10 to 50 μm, more preferably from 20 to 40 μm. A period of time for applying the voltage can be generally 2 to 4 minutes, though it varies with the electrodeposition condition.

After completion of the electrodeposition process, the electrodeposition coating film obtained in the manner as described above is optionally washed with water and then baked at a temperature of preferably 120 to 260° C., more preferably 140 to 220° C. for 10 to 30 minutes to cure, thereby the cured electrodeposition coating film is formed. By heating herein, the cationic emulsion (A) and the cationic emulsion (B) in the cationic electrodeposition coating composition are oriented by their solubility parameter, and the cationic emulsion (A) moves to the surface of electrically conductive substrate to form a resin layer and the cationic emulsions (B) moves to air-side to form a resin layer. In the oriented coating film, the cationic emulsion (B) having lower curing-initiation temperature (T_{B}) starts to cure before the cationic emulsion (A) starts to cure. Then the cationic emulsion (A) cures to provide curing strain on the coating film. The curing may be conducted by putting the coated substrate in an oven which has been heated to a required temperature, or putting it in an oven and then heating.

The appearance of the curing coating film is visually affected by surface profile, optical property and surface color of the coating film. In a test for wavelength, an example of evaluating appearance of the cured coating film using short wavelength light can evaluate roughness which is related to luster gloss or surface definition. On the other hand, regarding evaluation of roughness by using short wavelength, there is a limitation in wavelength range which one can recognize by one's eyes. For example, regarding roughness of a cured coating film which can only be evaluated in a short wavelength range of not greater than 0.32 μm, one can not recognize it has roughness but recognize by eye evaluation it is smooth. This coating film is deemed a coating film having less-luster gloss and smooth surface.

The cationic electrodeposition coating composition of the present invention can provide the cured electrodeposition coating film. The cationic electrodeposition coating composition of the present invention achieves less-luster gloss of the coating film owing to curing strain in heating, which provides the cured coating film having a visually-smooth surface and less-luster gloss such as specular gloss of not greater than 70%. The specular gloss as used herein is a value measured in geometry condition that incident optic axis is 60° and can be measured according to JIS K5600-4-7. The specular gloss is referred to “specular gloss at 600”.

### EXAMPLES

The present invention will be further explained in detail in accordance with the following examples, however, the present invention is not limited to these examples. In the examples, “part” is based on weight unless otherwise specified.

### Production Example 1

### Production of Cationic Epoxy Resin (1)

A flask equipped with a stirrer, a cooling tube, a nitrogen-introducing pipe, a thermometer, and a dropping funnel was filled with 92 parts of 2,4-/2,6-tolylene diisocyanate (ratio by weight=8/2), 95 parts of methyl isobutyl ketone (hereafter referred to as “MIBK”), and 0.5 part of dibutyltin dilaurate. With mixing the reaction mixture, 21 parts of methanol was added dropwise thereto. The reaction was started at room temperature, and reached to 60° C. by exothermic heat. The reaction was mainly conducted for 30 minutes, then 50 parts of ethylene glycol mono-2-ethylhexyl ether was added dropwise thereto with a dropping funnel. Five-mol-propyleneoxide adduct of Bisphenol A (53 parts) was added to the reaction mixture. The reaction was mainly conducted within a range of from 60 to 65° C., and was continued until absorption based on isocyanate groups disappeared by measurement of IR spectrum.

Next, 365 parts of epoxy resin having an epoxy equivalent of 188, which had been synthesized from bisphenol A and epichlorohydrin by a known method, was added to the reaction mixture, and then the temperature was raised to 125° C. Thereafter, 1.0 part of benzyldimethylamine was added to react at 130° C. until the epoxy equivalent was 410.

Subsequently, 61 parts of bisphenol A and 33 parts of octylic acid were added to react at 120° C., whereby the epoxy equivalent was 1190. Thereafter, the reaction mixture was cooled; 11 parts of diethanolamine, 24 parts of N-ethylethanolamine and 25 parts of 79% by weight solution in MIBK of ketimined aminoethyl ethanolamine were added; and the reaction was carried out at 110° C. for two hours. Thereafter, the resultant was diluted with MIBK until the non-volatile content of 80%, thereby to obtain a cationic epoxy resin (1) (with solid resin content of 80%).

### Production Example 2

### Production of Cationic Epoxy Resin (2)

A flask equipped with a stirrer, a cooling tube, a nitrogen-introducing pipe, a thermometer, and a dropping funnel was filled with 92 parts of 2,4-/2,6-tolylene diisocyanate (ratio by weight=8/2), 95 parts of methyl isobutyl ketone (hereafter referred to as “MIBK”), and 0.5 part of dibutyltin dilaurate. With mixing the reaction mixture, 21 parts of methanol was added dropwise thereto. The reaction was started at room temperature, and reached to 60° C. by exothermic heat. The reaction was mainly conducted for 30 minutes, then 50 parts of ethylene glycol mono-2-ethylhexyl ether was added dropwise thereto with a dropping funnel. Five-mol-propyleneoxide adduct of Bisphenol A (53 parts) was added to the reaction mixture. The reaction was mainly conducted within a range of from 60 to 65° C., and was continued until absorption based on isocyanate groups disappeared by measurement of IR spectrum.

Next, 365 parts of epoxy resin having an epoxy equivalent of 188, which had been synthesized from bisphenol A and epichlorohydrin by a known method, was added to the reaction mixture, and then the temperature was raised to 125° C. Thereafter, 1.0 part of benzyldimethylamine was added to react at 130° C. until the epoxy equivalent was 410.

Subsequently, 61 parts of bisphenol A and 10.0 parts of octylic acid were added to react at 120° C., whereby the epoxy equivalent was 1190. Thereafter, the reaction mixture was cooled; 11 parts of diethanolamine, 24 parts of N-ethylethanolamine and 25 parts of 79% by weight solution in MIBK of ketimined aminoethyl ethanolamin were added; and the reaction was carried out at 110° C. for two hours. Thereafter, the resultant was diluted with MIBK until the non-volatile content of 80%, thereby to obtain a cationic epoxy resin (2) (with solid resin content of 80%).

### Production Example 3

### Production of a Cation-Modified Acrylic Resin

A flask equipped with a stirrer, a thermometer, a decanter, a reflux cooling tube, a nitrogen-introducing pipe, and a dropping funnel was filled with 1000 parts of butyl cellosolve, and heated to 120° C. under nitrogen atmosphere. To the flask, an aqueous solution containing 13 parts of 4,4′-azobis-(4-cyanopentanoic acid); and a mixture of 250 parts of acrylic acid 4-hydroxybutyl ester, 70 parts of methacrylic acid 2-ethylhexyl ester, 480 parts of methacrylic acid n-butyl ester, 100 parts of methacrylic acid dimethylaminoethyl ester and 90 parts of acrylic acid 2-methoxyethyl ester; were added dropwise thereto in two lines for three hours, then the reaction was conducted for additional 3 hours at 115° C. The reaction mixture was cooled to obtain a cation-modified acrylic resin having amino group.

### Production Example 4

### Production of Blocked Isocyanate Curing Agent (1)

A reaction vessel was filled with 222.0 parts of isophorone diisocyanate (hereafter referred to as “IPDI”) and 39.1 parts of methyl isobutyl ketone (hereafter referred to as “MIBK”) and, heated to 50° C., to which 0.2 parts of dibutyltin dilaurate was added. Then, 131.5 parts of 2-ethylhexanol (hereafter referred to as “2EH”) was added dropwise thereto at 5° C. under dried nitrogen atmosphere for two hours. The reaction temperature was kept at 50° C. with optional cooling. Then, it was confirmed that an absorption based on isocyanate groups disappeared by measurement of IR spectrum. The mixture was being left to stand for cooling to obtain a blocked isocyanate curing agent (1) (resin solid content: 90.0%).

### Production Example 5

### Production of Blocked Isocyanate Curing Agent (2)

A reaction vessel was filled with 1250 parts of diphenylmethane diisocyanate and 266.4 parts of MIBK and, heated to 80° C., to which 2.5 parts of dibutyltin dilaurate was added. Into this, a solution obtained by dissolving 226 parts of α-caprolactam into 944 parts of butyl cellosolve was added dropwise thereto at 80° C. for two hours. The mixture was then heated at 100° C. for four hours, it was confirmed that an absorption based on isocyanate groups disappeared by measurement of IR spectrum. After being left to stand for cooling, 336.1 parts of MIBK was added to obtain a blocked isocyanate curing agent (2) (resin solid content: 80.0%).

### Production Example 6

### Production of Blocked Isocyanate Curing Agent (3)

A reaction vessel was filled with 1250 parts of diphenylmethane diisocyanate and 266.4 parts of MIBK and, heated to 80° C., to which 2.0 parts of dibutyltin dilaurate was added. Into this, 1533 parts of di(ethylene glycol) butyl ether was added dropwise thereto at 80° C. for two hours. The mixture was then heated at 100° C. for four hours, it was confirmed that an absorption based on isocyanate groups disappeared by measurement of IR spectrum. After being left to stand for cooling, 211.0 parts of MIBK was added to obtain a blocked isocyanate curing agent (3) (resin solid content: 87.0%).

### Production Example 7

### Production of Blocked Isocyanate Curing Agent (4)

A reaction vessel was filled with 222.0 parts of hexamethylene diisocyanate and 97.0 parts of methyl isobutyl ketone and, heated to 50° C., to which 0.2 parts of dibutyltin dilaurate was added. Into this, 186.0 parts of methyl ethyl ketoxime was added dropwise thereto at 50° C. under dried nitrogen atmosphere for two hours. The reaction temperature was kept at 50° C. with optional cooling. Then, it was confirmed that an absorption based on isocyanate groups disappeared by measurement of IR spectrum. The mixture was being left to stand for cooling to obtain a blocked isocyanate curing agent (4) (resin solid content: 90.0%).

### Production Example 8

### Production of Blocked Isocyanate Curing Agent (5)

A reaction vessel was filled with 480.2 parts of Norbornane diisocyanate methyl (a mixture of 2,5- and 2,6-(bis isocyanatomethyl)bicyclo[2.2.1]heptanes) and 78.2 parts of methyl isobutyl ketone and, heated the mixture to 70° C., to which 0.1 parts of dibutyltin dilaurate was added. Into this, 319.8 parts of furfuryl alcohol was added dropwise thereto. The reaction mixture generated heat and was mixed within a range of from 75 to 85° C. for 30 minutes. After the mixture was cooled at 65° C., 121.7 parts of methyl ethyl ketoxime was added dropwise thereto using a dropping funnel. The reaction mixture generated heat and was mixed within a range of from 65 to 75° C. for 30 minutes. Then, it was confirmed that an absorption based on isocyanate groups disappeared by measurement of IR spectrum. The mixture was being left to stand for cooling to obtain a blocked isocyanate curing agent (5) (resin solid content: 80.0%).

### Production Example 9

### Production of Pigment Dispersing Resin

First, a reaction vessel equipped with a stirring apparatus, a cooling tube, a nitrogen-introducing pipe, and a thermometer was filled with 222.0 parts of isophorone diisocyanate (hereafter referred to as IPDI) and, after dilution with 39.1 parts of MIBK, 0.2 part of dibutyltin dilaurate was added. Thereafter, the temperature of this mixture was raised to 50° C., and 131.5 parts of 2-ethylhexanol was added dropwise thereto with stirring in a dried nitrogen atmosphere for two hours. By suitably cooling, the reaction temperature was maintained at 50° C. This resulted in 2-ethylhexanol half-blocked IPDI (having a solid resin content of 90.0%). Next, 87.2 parts of dimethylethanolamine, 117.6 parts of an aqueous solution of 75% lactic acid, and 39.2 parts of ethylene glycol monobutyl ether were successively added into a suitable reaction vessel, followed by stirring at 65° C. for about half an hour to prepare a quaternarizing agent.

Next, a suitable reaction vessel was filled with 710.0 parts of EPON 829 (bisphenol A-type epoxy resin manufactured by Shell Chemical Co., Ltd., epoxy equivalent: 193 to 203) and 289.6 parts of bisphenol A, followed by heating to 150 to 160° C. under nitrogen atmosphere to start an initial exothermic reaction. The reaction mixture was allowed to react at 150 to 160° C. for about one hour and then, after the resultant was cooled to 120° C., 498.8 parts of the 2-ethylhexanol half-blocked IPDI (MIBK solution) prepared in the above was added.

The reaction mixture was maintained at 110 to 120° C. for about one hour, and then 463.4 parts of ethylene glycol monobutyl ether was added. After the mixture was cooled to 85 to 95° C. to form a uniform mixture, 196.7 parts of the quaternarizing agent prepared in the above was added. After the reaction mixture was maintained at 85 to 95° C. until the acid value became 1, 964 parts of deionized water was added to complete the quaternarization in the epoxy bisphenol A resin, thereby to yield a pigment dispersing resin having quaternary ammonium group (solid resin content: 50%).

### Production Example 10

### Production of Pigment-Dispersed Paste

The modified epoxy resin having quaternary ammonium group obtained in Production Example 9 was used as a pigment-dispersing resin. Into a sand grind mill, 120 parts of the modified epoxy resin obtained in Production Example 9, 2.0 parts of carbon black, 100.0 parts of kaolin, 80.0 parts of titanium dioxide, 18.0 parts of aluminum phosphomolybdate, and 221.7 parts of ion exchanged water were filled, followed by dispersion until the particle size became equal to or less than 10 μm to yield a pigment paste (solid content: 48%).

### Example 1

The cationic epoxy resin (1) obtained in Production Example 1 and the blocked isocyanate curing agent (1) obtained in Production Example 4 were uniformly mixed in solid content ratio of 70/30. To the mixture, formic acid was added in such an amount that milligram equivalent value of acid based on 100 g of the binder resin emulsion solid content MEQ(A) was 30, then ion-exchanged water was slowly added for dilution. MIBK was removed under reduced pressure to obtain an emulsion (A-1) having a solid content of 36%. Solubility parameter δ_{A} of the emulsion (A-1) was 11.2.

The cation-modified acrylic resin obtained in Production Example 3 and the blocked isocyanate curing agent (4) obtained in Production Example 7 were uniformly mixed in solid content ratio of 70/30. To the mixture, formic acid was added in such an amount that milligram equivalent value of acid based on 100 g of the binder resin emulsion solid content MEQ(A) was 30, then ion-exchanged water was slowly added for dilution. MIBK was removed under reduced pressure to obtain an emulsion (B-1) having a solid content of 36%. Solubility parameter δ_{B} of the emulsion (B-1) was 10.6.

The emulsion (A-1) (1050 parts), 450 parts of the emulsion (B-1), 540 parts of the pigment-dispersed paste obtained in Production Example 10, 1960 parts of ion exchanged water and 10 parts of dibutyltin oxide were mixed to obtain a cationic electrodeposition coating composition having a solid content of 20%. A content of volatile organic compounds of the cationic electrodeposition coating composition was 0.5% by weight, and milligram equivalent value of acid based on 100 g of the resin solid content was 24.2.

### Example 2

The cationic epoxy resin (1) obtained in Production Example 1 and the blocked isocyanate curing agent (2) obtained in Production Example 5 were uniformly mixed in solid content ratio of 70/30. To the mixture, formic acid was added in such an amount that milligram equivalent value of acid based on 100 g of the binder resin emulsion solid content MEQ(A) was 30, then ion-exchanged water was slowly added for dilution. MIBK was removed under reduced pressure to obtain an emulsion (A-2) having a solid content of 36%. Solubility parameter δ_{A} of the emulsion (A-2) was 11.1.

The emulsion (A-2) (1050 parts), 450 parts of the emulsion (B-1) (δ_{B}=10.6) obtained in Example 1, 540 parts of the pigment-dispersed paste obtained in Production Example 10, 1960 parts of ion exchanged water and 10 parts of dibutyltin oxide were mixed to obtain a cationic electrodeposition coating composition having a solid content of 20%. A content of volatile organic compounds of the cationic electrodeposition coating composition was 0.5% by weight, and a milligram equivalent value of acid based on 100 g of the solid content of the resin was 24.2.

### Example 3

The cationic epoxy resin (1) obtained in Production Example 1 and the blocked isocyanate curing agent (3) obtained in Production Example 6 were uniformly mixed in solid content ratio of 70/30. To the mixture, formic acid was added in such an amount that milligram equivalent value of acid based on 100 g of the binder resin emulsion solid content MEQ(A) was 30, then ion-exchanged water was slowly added for dilution. MIBK was removed under reduced pressure to obtain an emulsion (A-3) having a solid content of 36%. Solubility parameter δ_{A} of the emulsion (A-3) was 11.6.

The emulsion (A-3) (1050 parts), 450 parts of the emulsion (B-1) (δ_{B}=10.6) obtained in Example 1, 540 parts of the pigment-dispersed paste obtained in Production Example 10, 1960 parts of ion exchanged water and 10 parts of dibutyltin oxide were mixed to obtain a cationic electrodeposition coating composition having a solid content of 20%. A content of volatile organic compounds of the cationic electrodeposition coating composition was 0.5% by weight, and a milligram equivalent value of acid based on 100 g of the solid content of the resin was 24.2.

### Example 4

The cationic epoxy resin (1) obtained in Production Example 1 and the blocked isocyanate curing agent (4) obtained in Production Example 7 were uniformly mixed in solid content ratio of 70/30. To the mixture, formic acid was added in such an amount that milligram equivalent value of acid based on 100 g of the binder resin emulsion solid content MEQ(A) was 30, then ion-exchanged water was slowly added for dilution. MIBK was removed under reduced pressure to obtain an emulsion (A-4) having a solid content of 36%. Solubility parameter δ_{A} of the emulsion (A-4) was 11.4.

The cation-modified acrylic resin obtained in Production Example 3 and the blocked isocyanate curing agent (5) obtained in Production Example 8 were uniformly mixed in solid content ratio of 70/30. To the mixture, formic acid was added in such an amount that milligram equivalent value of acid based on 100 g of the binder resin emulsion solid content MEQ(A) was 30, then ion-exchanged water was slowly added for dilution. MIBK was removed under reduced pressure to obtain an emulsion (B-2) having a solid content of 36%. Solubility parameter δ_{B} of the emulsion (B-2) was 10.4.

The emulsion (A-4) (1200 parts), 300 parts of the emulsion (B-2), 540 parts of the pigment-dispersed paste obtained in Production Example 10, 1960 parts of ion exchanged water and 10 parts of dibutyltin oxide were mixed to obtain a cationic electrodeposition coating composition having a solid content of 20%. A content of volatile organic compounds of the cationic electrodeposition coating composition was 0.5% by weight, and milligram equivalent value of acid based on 100 g of the resin solid content was 24.2.

### Comparative Example 1

The cationic epoxy resin (1) obtained in Production Example 1 and the blocked isocyanate curing agent (4) obtained in Production Example 7 were uniformly mixed in solid content ratio of 70/30. To the mixture, formic acid was added in such an amount that milligram equivalent value of acid based on 100 g of the binder resin emulsion solid content MEQ(A) was 30, then ion-exchanged water was slowly added for dilution. MIBK was removed under reduced pressure to obtain an emulsion (A-4) having a solid content of 36%. Solubility parameter δ_{A} of the emulsion (A-4) was 11.4.

The emulsion (A-4) (1050 parts), 450 parts of the emulsion (B-1) (δ_{B}=10.6) obtained in Example 1, 540 parts of the pigment-dispersed paste obtained in Production Example 10, 1960 parts of ion exchanged water and 10 parts of dibutyltin oxide were mixed to obtain a cationic electrodeposition coating composition having a solid content of 20%. A content of volatile organic compounds of the cationic electrodeposition coating composition was 0.5% by weight, and a milligram equivalent value of acid based on 100 g of the solid content of the resin was 24.2.

### Comparative Example 2

The cationic epoxy resin (2) obtained in Production Example 2 and the blocked isocyanate curing agent (2) obtained in Production Example 5 were uniformly mixed in solid content ratio of 70/30. To the mixture, formic acid was added in such an amount that milligram equivalent value of acid based on 100 g of the binder resin emulsion solid content MEQ(A) was 30, then ion-exchanged water was slowly added for dilution. MIBK was removed under reduced pressure to obtain an emulsion (A-4) having a solid content of 36%. Solubility parameter δ_{A} of the emulsion (A-4) was 10.8.

The emulsion (A-4) (1050 parts), 450 parts of the emulsion (B-1) (δ_{B}=10.6) obtained in Example 1, 540 parts of the pigment-dispersed paste obtained in Production Example 10, 1960 parts of ion exchanged water and 10 parts of dibutyltin oxide were mixed to obtain a cationic electrodeposition coating composition having a solid content of 20%. A content of volatile organic compounds of the cationic electrodeposition coating composition was 0.5% by weight, and a milligram equivalent value of acid based on 100 g of the solid content of the resin was 24.2.

The cationic electrodeposition coating compositions obtained in the above Examples and Comparative Examples were evaluated in the following way.

Measurement of a Curing-Initiation Temperature

Dynamic viscoelasticity of the cationic emulsion (A) and cationic emulsion (B) used in the preparation of the cationic electrodeposition coating composition in Examples and Comparative Examples were measured using RHEOSOL-G3000 produced by UBM CORPORATION under temperature-dependent condition at basic frequency of 1 Hz. A regression line 1 of temperature and viscosity in the uncure state before heat-curing and a regression line 2 of temperature and viscosity in the state on curing were made. Then, a temperature at the intersection of the line 1 with the line 2 was obtained and the temperature was called “curing-initiation temperature (T_{A})” or “curing-initiation temperature (T_{B})”

Measurement of Specular Gloss at 60°

Gloss of the surfaces of the cured electrodeposition coating film was measured three times using micro-gloss 60° (produced by BYK Gardner corporation) according to JIS K5600-4-7. A mean value of the measurements of gloss was calculated.

Measurement of Arithmetical Mean Roughness of Roughness Profile (Ra)

The Ra value of the cured electrodeposition coating film obtained from the electrodeposition coating composition were measured using an evaluation type surface roughness tester (SURFTEST SJ-201P) manufactured by Mitutoyo Corporation according to JIS-B 0601. The measurement was conducted seven times using a sample comprising cutoff of 2.5 mm width (section number: 5), and Ra value determined from an average obtained by removing the upper and lower values. The results are shown in Table 1. The arithmetical mean roughness (Ra) obtained from a roughness profile as used herein is a parameter defined in JIS B 0601. The cured electrodeposition coating film with smaller Ra value has excellent surface appearance. JIS B 0601 is a Japanese Industrial Standards that is translation of ISO 4278 in 1997 without any change of technical content or form of standard.

The results are shown in Table 1.

TABLE 1

| | | | | | | comparative | comparative |
|---|---|---|---|---|---|---|---|
| | | Example 1 | Example 2 | Example 3 | Example 4 | example 1 | example 2 |
| emulsion | T_{A} | 140 | 145 | 155 | 135 | 135 | 145 |
| (A) | δ_{A} | 11.2 | 11.1 | 11.6 | 11.4 | 11.4 | 10.8 |
| emulsion | T_{B} | 120 | 120 | 120 | 110 | 120 | 120 |
| (B) | δ_{B} | 10.6 | 10.6 | 10.6 | 10.4 | 10.6 | 10.6 |

| | | | | | | |
|---|---|---|---|---|---|---|
| ΔT_{A-B} | 20 | 25 | 35 | 25 | 15 | 25 |
| Δδ_{A-B} | 0.6 | 0.5 | 1.0 | 1.0 | 0.8 | 0.2 |
| solid content ratio A/B of | 70/30 | 70/30 | 70/30 | 80/20 | 70/30 | 70/30 |
| emulsion (A) and emulsion (B) | | | | | | |
| specular gloss at 60° | 69 | 66 | 60 | 68 | 80 | 84 |
| Ra (μm) (Cutoff 2.5) | 0.25 | 0.23 | 0.24 | 0.24 | 0.23 | 0.24 |

The results in Table 1 shows that the electrodeposition coating composition of the present invention in the Examples can provide the cured electrodeposition coating film having less-luster gloss such as a specular gloss at 600 of not greater than 70% by electrocoating. The cured electrodeposition coating film of the present invention also has Ra value of not greater than 0.3 μm and excellent surface condition. On the other hand, in Comparative Examples, the electrodeposition coating film having less-luster gloss was not obtained.

The cationic electrodeposition coating composition of the present invention can provide a electrodeposition coating film having low specular gloss (less-luster gloss) and excellent finished appearance by electrocoating the cationic electrodeposition coating composition. The cationic electrodeposition coating composition of the present invention can provide the cured electrodeposition coating film having a low specular gloss without a particulate additive for mat coating film. The cationic electrodeposition coating composition has a great deal of potential in industry of coating big substrates with requirement of excellent design property such as automobile coating.

1. A cationic electrodeposition coating composition comprising a cationic emulsion (A) which comprises (a) a cationic epoxy resin and (c) a blocked isocyanate curing agent, and a cationic emulsion (B) which comprises (b) at least one resin selected from the group consisting of a cation-modified acrylic resin and a cationic epoxy resin other than the cationic epoxy resin (a) and (d) a blocked isocyanate curing agent, wherein
a difference Δδ_{A-B} between a solubility parameter δ_{A} of a resin component in the cationic emulsion (A) and a solubility parameter δ_{B} of a resin component in the cationic emulsion (B) is within a range of from 0.5 to 1.5, and
a difference ΔT_{A-B} between a curing-initiation temperature (T_{A}) of the cationic emulsion (A) and a curing-initiation temperature (T_{B}) of the cationic emulsion (B) is within a range of from 20° C. to 60° C.

2. A cationic electrodeposition coating composition according to claim 1, wherein a solid content ratio A/B by weight of the cationic emulsion (A) and the cationic emulsion (B) is within a range of from 95/5 to 60/40.

3. A process for forming a cured electrodeposition coating film having a specular gloss within a range of from 50% to 70%, comprising the steps of;
electrocoating a cationic electrodeposition coating composition comprising a cationic emulsion (A) which comprises (a) a cationic epoxy resin and (c) a blocked isocyanate curing agent, and a cationic emulsion (B) which comprises (b) at least one resin selected from the group consisting of a cation-modified acrylic resin and a cationic epoxy resin other than the cationic epoxy resin (a) and (d) a blocked isocyanate curing agent, wherein a difference Δδ_{A-B} between a solubility parameter δ_{A} of a resin component in the cationic emulsion (A) and a solubility parameter δ_{B} of a resin component in the cationic emulsion (B) is within a range of from 0.5 to 1.5, and
a difference ΔT_{A-B} between a curing-initiation temperature (TA) of the cationic emulsion (A) and a curing-initiation temperature (T_{B}) of the cationic emulsion (B) is within a range of from 20° C. to 60° C., and
heating the resulting electrodeposition coating film to cure.
